(19) United States
(12) Patent Application Publication
(10) Pub. No.: US 2023/0373764 A1
(43) Pub. Date: Nov. 23, 2023

(54) Forestry Winch with an Eject Roller

(71) Applicant: Bernward Welschof, Grossostheim (DE)

(72) Inventors: Bernward Welschof, Grossostheim (DE); Claus Hofmann, Haibach (DE); Michael Willenbücher, Oberzent (DE)

(21) Appl. No.: 18/247,150

(22) PCT Filed: Sep. 13, 2021
(86) PCT No.: PCT/EP2021/075053

§ 371 Date: Mar. 29, 2023

(30) Foreign Application Priority Data
Sep. 30, 2020 (DE) 10 2020 125 559.4

(51) Int. Cl. B66D 1/36; B66D 1/74; B66D 1/08; A01G 23/00

(52) U.S. Cl. CPC B66D 1/36; B66D 1/7415; B66D 1/08; A01G 23/003

(57) ABSTRACT

A forestry winch that has a rope drum driven by a drive motor and an ejector roller driven by an additional drive motor is disclosed. A rope is guided from the rope drum to the ejector roller and is guided over the ejector roller. The additional drive motor is located on the ejector roller and is connected to an energy supply device by means of energy supply lines. Provided on the ejector roller a protective device, which covers the energy supply lines located in the area of the additional drive motor and protects them from mechanical damage.

### CROSS-REFERENCE TO RELATED APPLICATIONS

This application is the United States national phase of International Application No. PCT/EP2021/075053 filed Sep. 13, 2021, and claims priority to German Patent Application No. 10 2020 125 559.4 filed Sep. 30, 2020, the disclosures of which are hereby incorporated by reference in their entireties.

### BACKGROUND OF THE INVENTION

### Field of the Invention

The invention relates to a forestry winch that has a rope drum driven by a drive motor and an ejector roller driven by an additional drive motor, wherein a rope is guided from the rope drum to the ejector roller and is guided over the ejector roller, and wherein the additional drive motor is located on the ejector roller and is connected to an energy supply device by means of energy supply lines.

### Description of Related Art

On forestry winches of the prior art it is known that a rope located on the rope drum is guided over a driven ejector roller. With the ejector roller driven by the drive motor, as the rope is unspooled from the rope drum and as it is spooled onto the rope drum, a desired rope tension can be applied to the rope, which makes possible a safe and correct unspooling of the rope from the rope drum when the rope is being unspooled and a safe and correct spooling of the rope onto the rope drum as the rope is being taken up. With the rope tension applied to the rope by the driven ejector roller, less effort is also required on the part of an operator who must pull the rope over significant distances of up to 100 m as the rope is being unspooled from the rope drum.

The additional drive motor provided for the drive of the ejector roller is hereby located directly on the ejector roller and for its energy supply is connected with an energy supply device by means of energy supply lines. On forestry winches of the prior art, the sections of the energy supply lines connected to the additional drive motor of the ejector roller are laid outdoors and, therefore, when the forestry winch is used in the forest, can easily be damaged or torn by branches, twigs or other interfering edges, as a result of which the reliability of the forestry winch is reduced.

### SUMMARY OF THE INVENTION

The object of this invention is to make available a forestry winch of the type described above with which reliability can be increased in a simple manner.

The invention teaches that this task is accomplished by providing a protective device on the ejector roller that covers the energy supply lines located in the area of the additional drive motor and protects them from mechanical damage.

According to the invention, therefore, the invention is provided with a protective device on the ejector roller that covers the energy supply lines located in the area of the additional drive motor and protects them from mechanical damage. As a result, the sections of the energy supply lines connected to the additional drive motor of the ejector roller can be protected in a safe and simple manner from mechanical damage or being torn off by contact with trunks, branches or other interfering edges so that the reliability of the forestry wince can be improved.

According to one advantageous embodiment of the invention, the protective device is in the form of a helmet-like cover on the ejector roller, underneath which the energy supply lines located in the area of the additional drive motor are arranged. With a helmet-like cover, underneath which the energy supply lines located in the area of the additional drive motor are arranged, the sections of the energy supply lines connected to the additional drive motor of the ejector roller can be protected in a particularly simple and secure manner from mechanical damage or being torn off by contact with branches, twigs or other interfering edges.

If, according to one advantageous embodiment of the invention, the cover is a metal cover, the result is a high degree of stability of the cover, so that the cover can also absorb high forces in the event of contact with branches, twigs or other interfering edges.

According to one advantageous development of the invention, the rope is pressed against the ejector roller by means of a pressing device, wherein the pressing device is located underneath the helmet-like cover. The rope is pressed against the ejector roller by means of the pressing device to achieve a corresponding transmission of force from the driven ejector roller to the rope and to achieve the desired rope tension on the rope. If the pressing device is also located underneath the helmet-like cover, the pressing device can also be protected simply and securely from mechanical damage, as a result of which the reliability of the forestry winch is further increased.

Additional advantages can be achieved if, according to one advantageous embodiment of the invention, the ejector roller is rotatably mounted on a bearing block which is pivotably mounted with a bearing journal so that it can pivot around a bearing component, wherein the bearing journal is a hollow shaft and the rope leading from the rope drum to the ejector roller is guided to the ejector roller in the bearing journal which is in the form of a hollow shaft. As a result, the ejector roller has the ability to pivot around a vertical pivoting axis. The guidance of the rope from the rope winch to the ejector roller in the bearing journal, which is in the form of a hollow shaft, of the ejector roller results in a protected guidance of the rope and a protected location of the rope in the bearing journal, which is in the form of a hollow shaft, and beneath the cover to a rope outlet on the ejector roller.

According to one advantageous development of the invention, the energy supply lines located in the bearing journal, which is in the form of a hollow shaft, lead to the additional drive motor which is located on the ejector roller. As a result, the protection of the energy supply lines that lead to the additional drive motor located on the ejector roller can be further improved, because the energy supply lines coming from the energy supply device are guided and laid inside the bearing journal, which is in the form of a hollow shaft, of the ejector roller and beneath the cover to the drive motor located on the ejector roller.

For this purpose, in one advantageous development of the invention, the bearing journal in the form of a hollow shaft is provided with a partition that separates the hollow shaft into a first compartment and a second compartment, wherein the rope leading to the ejector roller is located in the first compartment and the energy supply lines leading to the additional drive motor located on the ejector roller are located in the second compartment. As a result of the guidance and routing of the rope and the energy supply lines in compartments of the hollow shaft which are separated from each other by a partition, mechanical contact between the energy supply lines and the rope in the area of the hollow shaft can be prevented, so that the energy supply lines can be protected in a simple manner against fraying caused by the rope as the rope is moved by the winch during unspooling and spooling.

### BRIEF DESCRIPTION OF THE DRAWINGS

Additional advantages and details of the invention are described in greater detail below with reference to the exemplary embodiments illustrated in the accompanying schematic figures, in which

FIG. 1 is a view in perspective of a forestry machine with a forestry winch according to the invention,

FIG. 2 shows the forestry winch from FIG. 1 in a schematic illustration,

FIG. 3 shows the ejector roller in FIG. 2 in an enlarged illustration,

FIG. 4 is an illustration of the ejector roller without the protective device,

FIG. 5 shows the ejector roller from FIG. 4 with the protective device, and

FIG. 6 is a section through the bearing bolt of the ejector roller along line A-A in FIG. 3.

### DESCRIPTION OF THE INVENTION

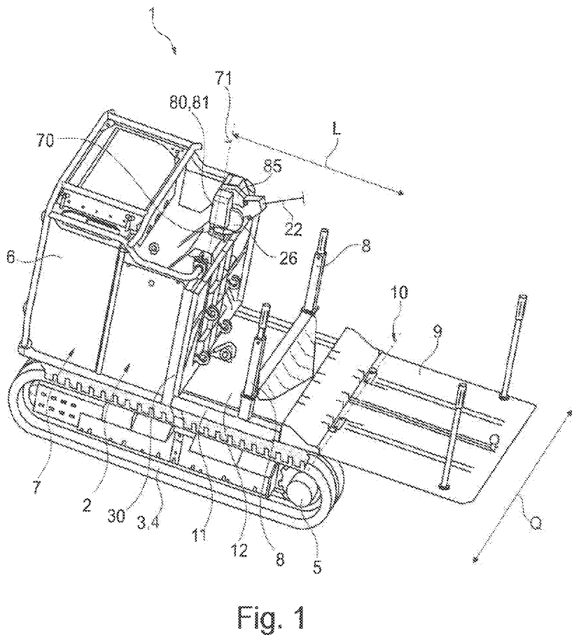

In FIG. 1, a mobile forestry machine 1 with a forestry winch 2 according to the invention is shown in a perspective view. In the illustrated example, the forestry machine 1 is in the form of a remotely controlled forestry machine.

The forestry machine 1 comprises a chassis 3, which is formed by tracks 4, each of which is driven by a hydraulic traction drive motor 5, for example. The traction drive motors 5, seen in the longitudinal direction L of the vehicle, are each located on the respective rear end, i.e. on the stern of the vehicle, of the tracks 4.

The forestry machine 1 has a hood 6, beneath which an energy supply device 7 and a forestry winch 2 are located. The forestry winch 1 also has a stanchion 8 and an adjustable ramp plate 9, which is located on the vehicle front of a vehicle body 11 so that it can be adjusted around a horizontal transverse vehicle axis 10. The forestry machine 1 does not have a driver workplace for an operator and can be operated remotely by an operator by means of a remote control, which is not illustrated in any further detail. The energy supply device 7 can have an internal combustion engine that drives one or more hydraulic pumps of a hydraulic system of the forestry machine 1, which supply the traction drive motors 5 and additional hydraulic consumers of the forestry machine 1.

On the front of the forestry machine 1 according to the invention, viewed in the longitudinal direction L of the vehicle are the energy supply device 7, adjacent to the energy supply device 7 the forestry winch 2, adjacent to the forestry winch 2 the stanchion 8 and, on the stern of the vehicle, the adjustable ramp plate 9. Therefore, viewed in the longitudinal direction L, the forestry winch 2 is located between the stanchion 8 and the energy supply device 7.

The stanchion 8 is located in the vertical direction above a base plate 12 of the vehicle body 11.

The energy supply device 7 and the forestry winch 2 are located in a forward half of the forestry machine 1. The base plate 12 with the stanchion 8 on it forms a rear half of the forestry machine 1.

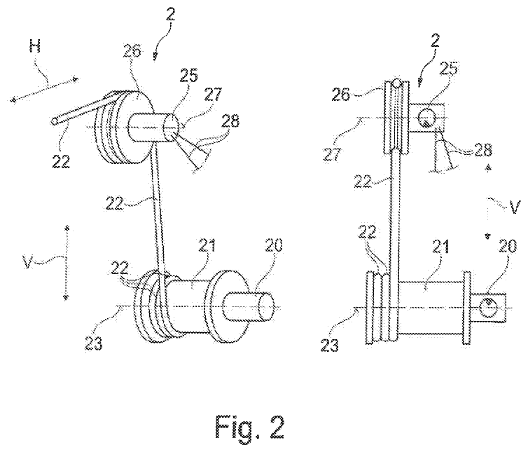

FIG. 2 is a schematic illustration of a forestry winch 2 according to the invention. The illustration on the left in FIG. 2 shows a view in perspective and the illustration on the right shows a head-on view of the forestry winch 2 according to the invention.

The forestry winch 2 has a rope drum 21, which is driven by a drive motor 20 and on which a rope 22, for example a steel rope, is spooled. The rope drum 21 can rotate around an axis of rotation 23 and is driven by the drive motor 20. The drive motor 20 can be a hydraulic motor, for example.

The forestry winch 2 also has an ejector roller 26 driven by an additional drive motor 25. The ejector roller 26 can rotate around an axis of rotation 27 and is driven by the drive motor 25. The drive motor 25 can be a hydraulic motor, for example. The drive motor 25 is preferably located directly on the ejector roller 26.

The rope 22 is guided from the rope drum 21 in the vertical direction V to the ejector roller 26, guided over the ejector roller 26 and deflected on the ejector roller 26 so that the rope 22 is guided away from the ejector roller 26 in the horizontal direction H.

The drive motor 20 of the rope drum 21 and the drive motor 25 of the ejector roller 26 are connected for their energy supply with the energy supply device 7. For this purpose, the drive motor 25 of the ejector roller 26 is connected with the energy supply device 7 by means of the energy supply lines 28. When the drive motor 25 is in the form of a hydraulic motor, the energy supply lines 28 are preferably formed by hose lines that are connected to the hydraulic unit located inside the hood 6. It goes without saying that alternatively, the drive motor 25 can be an electric motor and the energy supply lines 28 can be electric cables.

The ejector roller 26—as visible in FIG. 1—is located on the upper side of a vertical bulkhead 30 of the vehicle body 11 of the forestry machine 1, which extends in the transverse direction Q of the forestry machine 1 and is located between the forward half and the rear half of the forestry machine 1.

The rope drum 21 is located inside the hood 6.

The rope 22 is pressed on the ejector roller 26 by means of a pressing device 35 which is not illustrated in any further detail in FIG. 2 for the sake of simplicity.

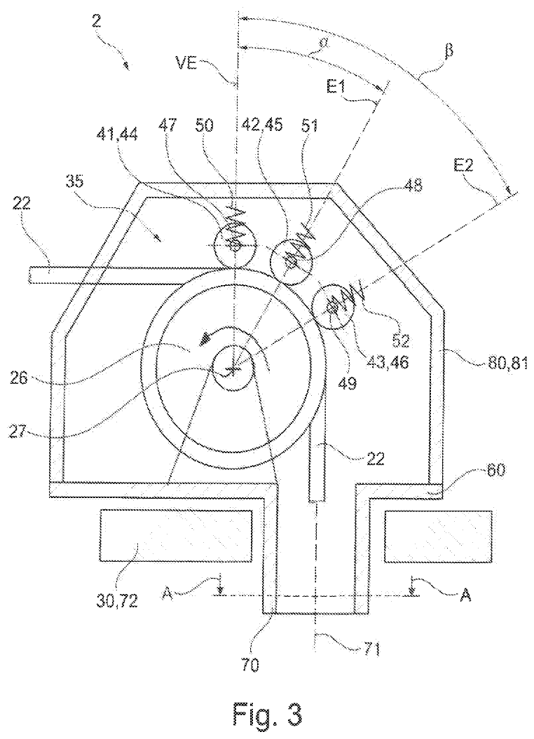

FIG. 3 shows the ejector roller 26 from FIGS. 1 and 2 with the pressing device 35 in a side view.

In the illustrated exemplary embodiment the pressing device 35 has at least three pressing elements 41, 42, 43, which are distributed around the periphery of the ejector roller 26.

The pressing elements 41, 42, 43 are each in the form of rotatable pinch rollers 44, 45, 46. The pinch roller 44 is arranged so that can rotate around an axis of rotation 47, the pinch roller 45 around an axis of rotation 48, and the pinch roller 46 around an axis of rotation 49. In the illustrated exemplary embodiment, the axes of rotation 47, 48, 49 of the respective pinch rollers 44, 45, 46 are oriented parallel to the axis of rotation 27 of the ejector roller 26. Each pinch roller 44, 45, 46 is biased toward the ejector roller 26 by means of a respective biasing device 50, 51, 52. In the illustrated exemplary embodiment, the biasing devices 50, 51, 52 are each in the form of a spring element, for example compression springs.

The first pressing element 41 and, therefore, the first pinch roller 44 is oriented in a vertical plane VE. The axis of rotation 27 of the ejector roller 26 and the axis of rotation 47 of the first pinch roller 44 are oriented in the vertical plane VE. The second pressing element 42 and therefore the second pinch roller 45 is oriented in the wrapping direction of the rope 22 on the ejector roller 26 in a plane E1 that is inclined at an angle α with respect to the vertical plane VE.

The axis of rotation 27 of the ejector roller 26 and the axis of rotation 48 of the second pinch roller 45 are oriented in the plane E1. The angle α is in the range of 10°-45°, in the illustrated exemplary embodiment 30°.

The third pressing element 43 and, therefore, the third pinch roller 46 is oriented in the wrapping direction of the rope 22 on the ejector roller 26 in a plane E2 that is inclined at an angle β with respect to the vertical plane VE. The axis of rotation 27 of the ejector roller 26 and the axis of rotation 49 of the third pinch roller 46 are oriented in the plane E2. The angle β is in the range of 45°-90°, in the illustrated exemplary embodiment 60°.

With the three pinch rollers 44, 45, 46 and the rope 22 guided in the vertical direction to the rope drum 21, the rope 22 can, therefore, be wrapped on the ejector roller 26 at a wrap angle of up to 90°.

In the illustrated exemplary embodiment, the ejector roller 26 and the pressing elements 41-43 in the form of rotatable pinch rollers 44-46 are rotatably mounted on a common bearing block 60. The pinch rollers 44-46 impinged by the spring devices 50-52 radially toward the ejector roller 26 can thereby be movably located with their axes of rotation 47-49 in corresponding slots of the bearing block 60.

The bearing block 60 on which the ejector roller 26 is mounted so that it can rotate around the axis of rotation 27—as illustrated in FIG. 3—is mounted with a bearing journal 70 so that it can pivot around a vertical pivoting axis 71 on the vertical bulkhead 30 that forms a bearing component 72.

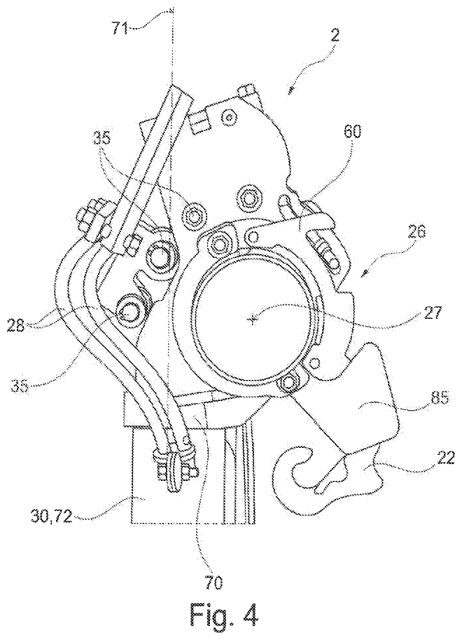

FIG. 4 illustrates the ejector roller 26 that is mounted on the top of the vertical bulkhead 30 by means of the bearing journal 70 of the bearing block 60 so that it can pivot around the vertical pivoting axis 71. FIG. 4 also shows the pressing elements 41, 42, 43 of the pressing device 35. FIG. 4 also shows the energy supply lines 28 in the form of hoses that lead to the drive motor 25 located on the ejector roller 26. In FIG. 4, the energy supply lines 28 are guided from the bulkhead 30 laterally next to the bearing journal 70 of the bearing block 60 of the ejector roller 26 to the drive motor 25 located on the ejector roller 26.

According to the invention, to protect the energy supply lines 28 running to the drive motor 25 located on the ejector roller 26 from damage caused by branches, twigs and other interfering edges, a protective device 80 is provided on the ejector roller 26 that covers the energy supply lines 28 located in the area of the additional drive motor 25 and protects them from mechanical damage. FIGS. 1, 3 and 5 show the ejector roller 26 with the protective device 80 placed on the ejector roller 26.

In the illustrated exemplary embodiment the protective device 80 is a helmet-like cover 81 which is placed on the ejector roller 26 and beneath which are arranged the energy supply lines 28 located in the area of the additional drive motor 25.

The cover 81 is preferably a metal cover.

Also located beneath the helmet-like cover 81 are the pressing device 35 and its pressing elements 41, 42, 43 and the rope 22 which is guided to a rope outlet 85 of the ejector roller 26. In the area of the helmet-like cover 81, the ejector roller 26 represents a protective device 80 for the energy supply lines 28, the pressing device 35 and the rope 22.

As shown in FIG. 3, the bearing journal 70 is in the form of a hollow shaft and the rope 22 guided from the rope drum 21 to the ejector roller 26 is guided to the ejector roller 26 in the bearing journal 70 which is in the form of a hollow shaft.

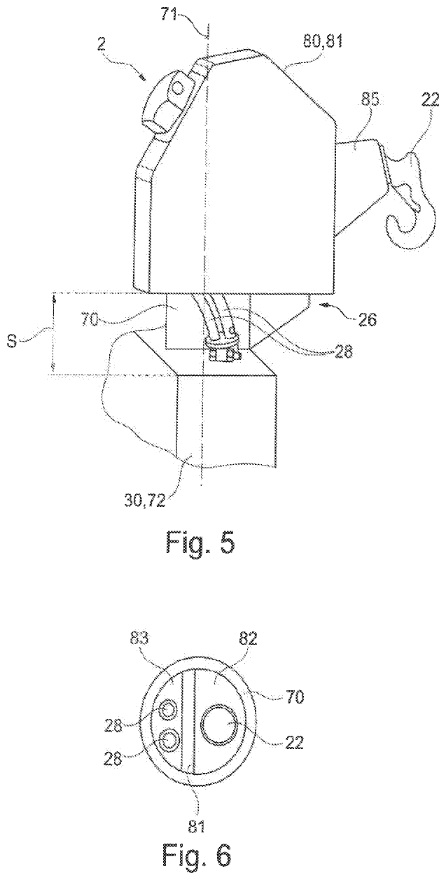

If the energy supply lines 28 are guided from the bulkhead 30 laterally next to the bearing journal 70 of the bearing block 60 of the ejector roller 26 to the drive motor 25 located on the ejector roller 26, depending on the vertical extension of the helmet-like cover 80—as shown in FIG. 5—a gap S can be left between the bottom of the helmet-like cover 81 and the top of the bulkhead 30 in which the energy supply lines 28 run unprotected.

To prevent this situation the energy supply lines 28—as illustrated in FIG. 6—can be guided in the bearing journal 70 in the form of a hollow shaft from the energy supply device 7 to the additional drive motor 25 located on the ejector roller 26.

For this purpose, the bearing journal 70 in the form of a hollow shaft is advantageously provided with a partition 81, which divides the interior of the hollow shaft into a first compartment 82 and a second compartment 83. The rope 22 leading from the rope drum 21 to the ejector roller is thereby located in the first compartment 82. The energy supply lines 28 leading to the additional drive motor 25 located on the ejector roller 26 are located in the second compartment 83.

The bearing journal 70 in the form of a hollow shaft of the ejector roller 26, therefore, forms a central pivot feed-through for the rope 22 and the energy supply lines 28, as a result of which the protection of the energy supply lines 28 leading to the drive motor 25 of the ejector roller 26 from damage by branches, twigs and other interfering edges can be further increased.

1. A forestry winch comprising a rope drum driven by a drive motor and an ejector roller driven by an additional drive motor, wherein a rope is guided from the rope drum to the ejector roller and is guided over the ejector roller, wherein the additional drive motor is located on the ejector roller and is connected to an energy supply device by energy supply lines, and wherein provided on the ejector roller is a protective device which covers the energy supply lines located in the area of the additional drive motor and protects the energy supply line against mechanical damage.

2. The forestry winch according to claim 1, wherein the protective device is in the form of a helmet-like cover on the ejector roller, and beneath which the energy supply lines located in the area of the additional drive motor are located.

3. The forestry winch according to claim 2, wherein the cover is in the form of a metal cover.

4. The forestry winch according to claim 2, wherein the rope is pressed against the ejector roller by pressing device, wherein the pressing device is located underneath the helmet-like cover.

5. The forestry winch according to claim 1, wherein the ejector roller is rotatably mounted on a bearing block which is pivotably mounted with a bearing journal so as to pivot around a vertical axis on a bearing component, and wherein the bearing journal is in the form of a hollow shaft and the rope leading from the rope drum to the ejector roller is guided to the ejector roller in the bearing journal.

6. The forestry winch according to claim 5, wherein the energy supply lines located in the bearing journal lead to the additional drive motor located on the ejector roller.

7. The forestry winch according to claim 6, wherein the bearing journal is provided with a partition that separates the hollow shaft into a first compartment and a second compartment, and wherein the rope leading to the ejector roller located in the first compartment and the energy supply lines leading to the additional drive motor located on the ejector roller are located in the second compartment.
